(19) United States
(12) Patent Application Publication
(10) Pub. No.: US 2022/0366295 A1
(43) Pub. Date: Nov. 17, 2022

(54) PRE-SEARCH CONTENT RECOMMENDATIONS

(71) Applicant: INTUIT INC., Mountain View, CA (US)

(72) Inventors: Prarit LAMBA, San Diego, CA (US); Steven Hidetaka KAWASUMI, San Diego, CA (US); Clifford GREEN, San Diego, CA (US)

(21) Appl. No.: 17/319,579

(22) Filed: May 13, 2021

(51) Int. Cl. G06N 20/00; G06F 16/2457

(52) U.S. Cl. CPC G06N 20/00; G06F 16/24575

(57) ABSTRACT

Aspects of the present disclosure provide techniques for training a machine learning model. Embodiments include providing features of a plurality of content items as inputs to an embedding model and receiving embeddings of the plurality of content items as outputs from the embedding model. Embodiments include receiving a data set comprising features of a plurality of users associated with content items of the plurality of content items that correspond to the plurality of users. Embodiments include generating a training data set for a machine learning model, wherein the training data set comprises the features of the plurality of users associated with respective labels indicating which respective embeddings of the embeddings correspond to each respective user of the plurality of users. Embodiments include training the machine learning model, using the training data set, to output corresponding embeddings of relevant content items for users based on features of the users.

### INTRODUCTION

Aspects of the present disclosure relate to techniques for using machine learning to determine content to provide to a user. In particular, techniques described herein involve the use of a first machine learning models to determine embeddings of content items for use by a second machine learning model to determine content items relevant to users.

### BACKGROUND

Every year millions of people, businesses, and organizations around the world utilize software applications to assist with countless aspects of life. As such, the ability to identify relevant content to provide to users via software applications is increasingly valuable. For example, recommending relevant help content to a user of a software application to assist with resolution of an issue related to the software application may allow issues to be resolved more efficiently, may save time and costs associated with technical support, and may improve the utility of the software application.

While some existing techniques involve determining relevant content to provide to users based on past user interactions with content, these techniques are not easily adapted to new content that has not yet been interacted with by users. Furthermore, these techniques may require significant amounts of historical data to produce accurate results, and may involve significant processing resources for analyzing the historical data. As such, there is a need in the art for improved techniques of determining relevant content to provide to users.

### BRIEF SUMMARY

Certain embodiments provide a method for training a machine learning model. The method generally includes: providing features of a plurality of content items as inputs to an embedding model; receiving embeddings of the plurality of content items as outputs from the embedding model based on the inputs; receiving a data set comprising features of a plurality of users associated with content items of the plurality of content items that correspond to the plurality of users; determining which respective embeddings of the embeddings correspond to each respective user of the plurality of users based on the data set and similarities among the embeddings; generating a training data set for a machine learning model, wherein the training data set comprises the features of the plurality of users associated with respective labels indicating which respective embeddings of the embeddings correspond to each respective user of the plurality of users; and training the machine learning model, using the training data set, to output corresponding vector representations of relevant content items for users based on features of the users.

Other embodiments provide a method for recommending content. The method generally includes: determining a plurality of features of a user; providing the plurality of features of the user as inputs to a machine learning model that has been trained to output embeddings of content items based on user features; receiving, from the machine learning model in response to the inputs, an output indicating one or more embeddings of content items; and determining, based on the one or more embeddings of content items, one or more content items to recommend to the user.

Other embodiments provide a system comprising one or more processors and a non-transitory computer-readable medium comprising instructions that, when executed by the one or more processors, cause the system to perform a method. The method generally includes: providing features of a plurality of content items as inputs to an embedding model; receiving embeddings of the plurality of content items as outputs from the embedding model based on the inputs; receiving a data set comprising features of a plurality of users associated with content items of the plurality of content items that correspond to the plurality of users; determining which respective embeddings of the embeddings correspond to each respective user of the plurality of users based on the data set and similarities among the embeddings; generating a training data set for a machine learning model, wherein the training data set comprises the features of the plurality of users associated with respective labels indicating which respective embeddings of the embeddings correspond to each respective user of the plurality of users; and training the machine learning model, using the training data set, to output corresponding vector representations of relevant content items for users based on features of the users.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of training a machine learning model for content prediction.

FIG. 2 depicts an example of a machine learning model for content prediction.

FIG. 3 depicts an example of content recommendation using machine learning techniques.

FIG. 4 depicts an example user interface screen for content recommendation using machine learning techniques.

FIGS. 5A and 5B depict example operations related to content recommendation using machine learning techniques.

FIGS. 6A and 6B depict example processing systems for content prediction using machine learning techniques.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for content recommendation.

According to certain embodiments, machine learning techniques are utilized in order to predict content likely to be relevant to a user, and content is recommended to the user based on the predictions. A first machine learning model may be used to generate “embeddings” (e.g., vector representations) of content items, such as based on titles of the content items, and may be referred to as an embedding model. The embeddings determined using the embedding model may be used, along with a data set indicating content items that were historically relevant to users having certain features, to train a second machine learning model (which may be referred to as a content prediction model) to output embeddings of content items likely to be relevant to a user with a given set of features. The embeddings output by the content prediction model may then be used to recommend content items to the user.

In some embodiments, “embeddings” of content items are generated by determining n-dimensional vectors representing titles of content items as vectors in n-dimensional space. For example, the embedding model used to generate embeddings may be a transformer model. Transformers are semi-supervised machine learning models that take an input sequence (e.g., a title of a content item) and use it to generate an output sequence (e.g., an embedding of the content item) one element at a time. A transformer model may, for instance, be a neural network, and may learn a representation (embedding) for a set of data through a training process that trains the neural network based on a data set such as a plurality of strings (e.g., titles of content items).

Neural networks generally include a plurality of connected units or nodes called artificial neurons. Each node generally has one or more inputs with associated weights, a net input function, and an activation function. Nodes are generally included in a plurality of connected layers, where nodes of one layer are connected to nodes of another layer, with various parameters governing the relationships between nodes and layers and the operation of the neural network.

In one example, the embedding model comprises a Bidirectional Encoder Representations from Transformer (BERT) techniques, which involve the use of masked language modeling to determine word embeddings. In other embodiments, the embedding model may involve existing embedding techniques, such as Word2Vec and GloVe embeddings. While some embodiments involve using titles of content items as input features to the embedding model to determine embeddings, other embodiments involve using other features of content items, such as additional text from the content items, as input features.

Machine learning models that determine embeddings, such as BERT models, tend to be large and may require significant amounts of processing and/or storage resources. Thus, aspects of the present disclosure involve a “transfer learning” process by which a content prediction model is trained for content recommendation based on knowledge gained from the embedding model (e.g., the embedding model). The content prediction model may be smaller, and may require smaller amounts of processing and/or storage resources than the embedding model, but is able to incorporate the knowledge of the embedding model into its training through transfer learning.

Accordingly, once embeddings are determined for a plurality of content items using the embedding model, the embeddings may be used as part of a training process for the content prediction model. By using embeddings determined using the embedding model to train a content prediction model for content prediction, the knowledge contained in the embedding model is distilled or transferred into the content prediction model.

For example, a data set indicating content items that were historically indicated to be relevant to users with particular features (e.g., based on historical interactions by the users with the content items) may be used along with the embeddings to generate a training data set. The training data set may comprise features of users (e.g., attributes known about users, clickstream data, and the like) associated with labels indicating embeddings of content items determined to be relevant to the users and, in some embodiments, identifiers of the relevant content items as well. The embeddings may be used to group content items with similar embeddings such that if a given user historically interacted with a first content item, and the first content item is determined to be similar to a second content item based on the embeddings (e.g., a similarity measure between the embedding of the first content item and the embedding of the second content item exceeds a threshold), then both the embedding of the first content item and the embedding of the second content item may be associated with features of the given user in the training data set.

The training data set may be used in a supervised learning process to train the content prediction model. In one example, the content prediction model is a neural network and comprises one or more long short term memory (LSTM) layers. In a neural network, each node or neuron in an LSTM layer generally includes a cell, an input gate, an output gate and a forget gate. The cell generally stores or “remembers” values over certain time intervals in both a backward direction (e.g., data input to the node) and a forward direction (e.g., data output by the node), and the gates regulate the flow of data into and out of the cell. As such, an LSTM layer hones a representation by modifying vectors based on remembered data, thereby providing a more contextualized representation of a text sequence.

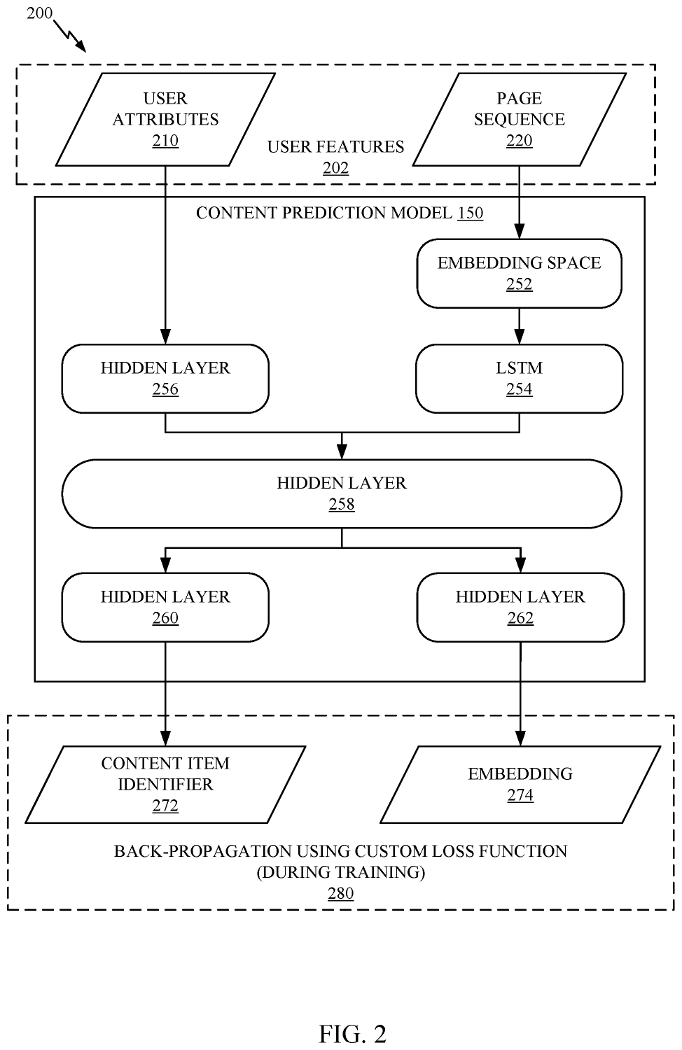

In some embodiments, training the content prediction model involves providing training inputs (e.g., features of users) to nodes of an input layer of the content prediction model. The content prediction model processes the training inputs through its various layers and outputs predicted embeddings (and, in some embodiments, identifiers) of content items, as depicted and described in more detail with respect to FIG. 2. The predicted embeddings (and, in some embodiment, identifiers) are compared to the labels associated with the training inputs to determine the accuracy of the given model, and parameters of the given model are iteratively adjusted until one or more conditions are met, such as based on an objective function. For example, the conditions may relate to whether the predictions produced by the given model based on the training inputs match the labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for each model, such as based on validation data and test data, as is known in the art.

In certain embodiments, a custom loss function is used to train the content prediction model. In the context of training a machine learning model, the function used to evaluate a candidate solution is referred to as the objective function. Optimizing an objective function may involve either maximizing or minimizing the objective function, which generally involves searching for a candidate solution that has the highest or lowest score. Generally, training a machine learning model involves minimizing error and, accordingly, the objective function may be referred to as a loss function (or sometimes a cost function). The value calculated by the loss function is referred to as loss. In some embodiments where the model is trained to output both embeddings and identifiers of content items, a custom loss function may penalize the model more heavily when it is not converging towards accuracy with respect to content item embeddings, and may penalize the model less heavily when it is not converging towards accuracy with respect to content item identifiers.

Once trained, the content prediction model may be used to predict content items likely to be relevant to a user with a given set of features. For example, user features such as attributes of the user and clickstream data of the user may be provided as inputs to the second machine learning model, and the machine learning model may output one or more embeddings and/or identifiers of content items likely to be relevant to the user. Content items may then be recommended to the user based on the outputs from the model.

In some embodiments, embeddings output by the model are used to identify additional content items (e.g., that may not have been included in the training data for the model) that are likely to be relevant to the user, such as based on similarity measures between embeddings. For instance, new content items may be created or become available after the training of the content prediction model. Embeddings of the new content items may be determined using the embedding model (e.g., as new content items become available), and the embeddings of the new content items may be stored and used at content prediction time by comparing them to embeddings output by the content prediction model for a given user in order to determine whether the new content items may also be relevant to the given user. Furthermore, the content prediction model may be re-trained as additional training data becomes available, such as based on new content items and/or feedback indicating content items that were in fact relevant to users (e.g., as users interact with content items recommended according to techniques described herein).

Embodiments of the present disclosure provide multiple improvements over conventional techniques for content recommendation. For example, by utilizing embeddings of content items instead of merely identifiers of content items to train a model for content prediction, techniques described herein allow for more dynamic and flexible determinations of relevant content items that is based on meaning associated with content items instead of being based only on rigid past associations between users and particular content items. Furthermore, embodiments of the present disclosure allow for the identification of new content items that may be relevant to a user, even if the new content items were not included in the training data for the model, based on similarities between embeddings.

Additionally, by making use of a custom loss function to train a machine learning model for content prediction, embodiments of the present disclosure allow the machine learning model to be optimized for predictions that are based on content item embeddings. The use of embeddings of content items further allows a machine learning model to be trained based not only on content items that have previously been determined to be relevant to users, but also based on content items that are similar to those content items that have previously been determined to be relevant to users, thereby increasing the training data and the set of possible outputs from the model.

Furthermore, by training a content prediction model based on embeddings determined using an embedding model, the knowledge of the embedding model is transferred into the content prediction model. Thus, while the embedding model may be large and require significant amounts of processing and storage resources, a smaller and more efficient content prediction model may be able to leverage the transferred knowledge of the embedding model in a more efficient model architecture, which allows for the content prediction model to use less energy and consume less space, and thus run on a wider range of devices. Accordingly, embodiments of the present disclosure provide improved machine learning techniques, and allow for improved content recommendation.

### Training a Model for Content Recommendation

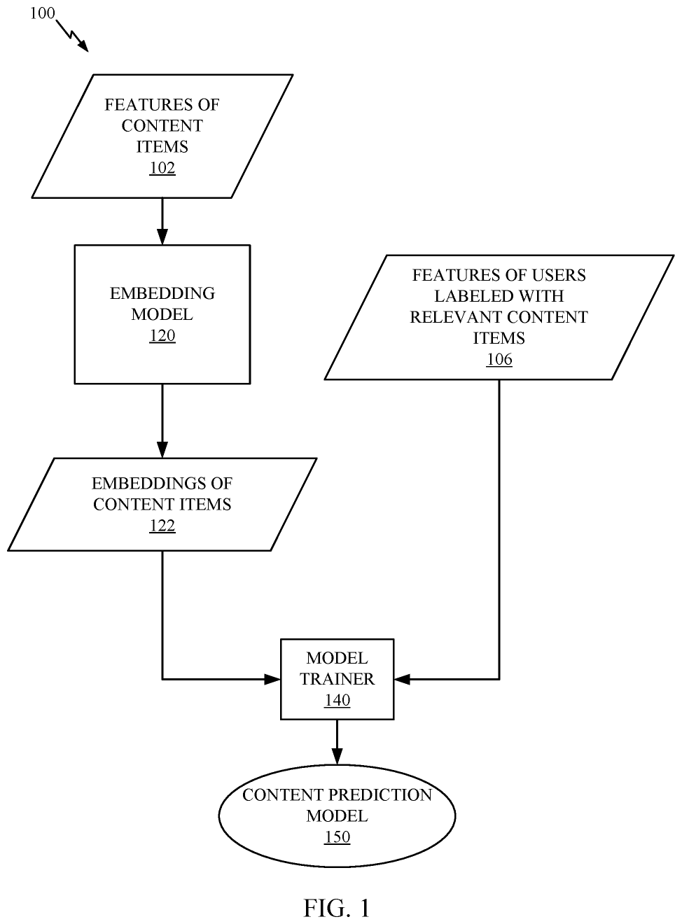

FIG. 1 is an illustration 100 of an example of training a machine learning model for content prediction.

An embedding model 120 represents a machine learning model that has been previously trained to output embeddings of content items based on features of the content items. For example, embedding model 120 may be a BERT model that has been trained based on known meanings of words to generate embeddings of content items (e.g., based on the words in the titles of the content items and/or words in other parts of the content items).

Features of content items 102 are provided as inputs to embedding model 120. In certain embodiments, features of content items 102 comprise titles of content items (e.g., text strings). The content items may include any type of content that may be recommended to a user, such as help articles related to a software application. Embedding model 120 outputs embeddings 122 for the content items based on the input features. Embeddings 122 may be vector representations of the content items that represent, for example, meanings of the titles of the content items as points in n-dimensional space.

### Preparing Training Data for a Content Prediction Model

Embeddings 122 determined using embedding model 120 are then used, along with features of users labeled with relevant content items 106, by a model trainer 140 to train a content prediction model 150. For example, model trainer 140 may generate a training data set in which each set of user features that is labeled with a given content item is associated with an embedding of the given content item and, in some embodiments, embeddings of other content items determined to be similar to the given content item (e.g., based on similarities between embeddings as described herein). Model trainer 140 generally represents a component that performs training operations, such as using supervised or semi-supervised learning techniques to train content prediction model 150. Features of users labeled with relevant content items 106 may, for example, include indications of content items that users with particular features have interacted with in the past, such as based on historical usage data. Features of users may include, for instance, user attributes such as occupation, geographic location, length of use of a software product, marital status, tax filing status, and other attributes that describe a user. Features of users may also include clickstream data, such as a sequence of pages of an application accessed by a given user prior to accessing a page on which content items are to be recommended, such as a help page. A set of features of a given user may be labeled with one or more relevant content items in 106 (e.g., the labels may comprise one or more identifiers of content items with which the given user has interacted).

Model trainer 140 may generate a training data set comprising features of users associated with embeddings of content items that correspond to the users. In certain embodiments, in order to generate the training data set, model trainer 140 determines which content items correspond to each user based on the labels in 106 as well as embeddings 122. For example, if a given user's features are associated with a first content item in 106 and a vector representation of the first content item is determined to be similar to a vector representation of a second content item included in embeddings 122, then both the first content item and the second content item may be determined to correspond to the given user. Two embeddings may be determined to be similar if a similarity measure between the two embeddings exceeds or falls below a threshold. In one example, distances between embeddings are determined, and if the distance between two embeddings is less than a threshold, then the two embeddings are determined to be similar. In one example, cosine similarity is used as a similarity measure between embeddings. Thus, the training data generated by model trainer 140 may include embeddings of content items that were not explicitly included in the labels in 106. In some embodiments, the training data also includes identifiers of the content items determined to correspond to each user. By including embeddings determined using embedding model 120 in the training data set for content prediction model 150, model trainer 140 utilizes a transfer learning process by which knowledge of embedding model 120 (which may be a large model) is transferred into content prediction model 150 (which may be a smaller and more efficient model). Thus, the benefits of the larger model are transferred to a smaller, more efficient model, which can process data with less energy, less model space, and less time. This allows for, in this example, the content prediction model 150 to beneficially be deployed on more types of devices, such as mobile devices.

There are many different types of machine learning models that can be used in embodiments of the present disclosure. For example, content prediction model 150 may be a neural network. Content prediction model 150 may also be an ensemble of several different individual machine learning models. Such an ensemble may be homogenous (i.e., using multiple member models of the same type) or non-homogenous (i.e., using multiple member models of different types). Individual machine learning models within such an ensemble may all be trained using the same subset of training data or may be trained using overlapping or non-overlapping subsets randomly selected from the training data.

Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. As described in more detail below with respect to FIG. 2, content prediction model 150 may be a neural network that comprises one or more LSTM layers.

### Using the Training Data to Train the Model

In some embodiments, training content prediction model 150 is a supervised learning process that involves providing training inputs (e.g., sets of user features) as inputs to content prediction model 150. Content prediction model 150 processes the training inputs and outputs predictions (e.g., embeddings and/or identifiers of content items) with respect to particular users represented by the features. Predictions may, in some embodiments, be in the form of probabilities with respect to each possible embedding and/or identifier, such as indicating a likelihood that a content item corresponding to the embedding and/or identifier is relevant to the user. The outputs are compared to the labels associated with the training inputs to determine the accuracy of content prediction model 150, and content prediction model 150 is iteratively adjusted until one or more conditions are met. For instance, the one or more conditions may relate to a custom loss function.

In some embodiments, back-propagation is used to train the model. Back-propagation refers to a process of calculating a gradient based on a loss function, comparing recreated input with the actual input. By propagating this gradient “back” through the layers of the model, the weights can be modified to produce more accurate outputs on subsequent attempts to recreate the input.

### Custom Loss Function

A loss function is a type of objective function used to minimize “loss” (e.g., the value calculated by the loss function) during training iterations for a machine learning model. Components included in a loss function may relate to the determined accuracy of the machine learning model during a given training iteration with respect to one or more particular conditions.

Minimizing a loss function during model training generally involves searching for a candidate solution (e.g., a set of model parameters including weights and biases, and the like) that produces the lowest value as calculated by the custom loss function.

In one particular example, a custom loss function is represented as follows: 400*(mean squared error+categorical_crossentropy). Mean squared error measures the average of the squares of the error, meaning the average squared difference between the predicted values (e.g., embeddings and/or identifiers output by the model during a training iteration) and the actual values (e.g., embeddings and/or identifiers in the labels in the training data). Cross-entropy generally measures the performance of a model whose output is a probability value between 0 and 1 (e.g., indicating a probability that a given content item identifier or embedding corresponds to a content item that is likely to be relevant to a user). Cross-entropy loss increases as the output probability diverges from the label indicated in the test data set (e.g., if the model outputs a low probability for a given embedding being relevant when the embedding is indicated by a label as being relevant). For example, predicting a probability of 0.014 when the label is 1 (e.g., when the label indicates that a content item corresponding to a given embedding or identifier was in fact relevant to a given user) would result in a higher loss value than predicting a probability of 0.9 when the label is 1. An ideal model would have a cross-entropy value of 0. Categorical cross-entropy includes a Softmax activation function in addition to cross-entropy loss. A Softmax activation function converts numeric outputs of the last linear layer of a multi-class classification neural network into probabilities by taking the exponents of each output and then normalizing each number by the sum of those exponents such that the entire output vector (e.g., including all of the probabilities) adds up to one. 400 is included as one example multiplier, and other examples are possible. In some embodiments, mean squared error and categorical cross-entropy are calculated for a given training iteration based on all outputs from the model (e.g., all embeddings and/or identifiers output by the model) in view of the labels in the training data.

Alternative embodiments of the custom loss function include, but are not limited to, (400*mean squared error)+categorical_crossentropy and, in another example, mean squared error+(400*categorical_crossentropy). As used herein, * is a multiplication operator.

According to certain embodiments of the present disclosure, a custom loss function includes a first component that relates to the model's accuracy with respect to embeddings of content items (e.g., such that a low accuracy with respect to embeddings causes an increase in loss) and a second component that relates to the model's accuracy with respect to identifiers of content items (e.g., such that a low accuracy with respect to identifiers also causes an increase in loss). In some embodiments, the first component may be weighted more heavily than the second component in the calculation such that low accuracy with respect to embeddings results in higher loss than low accuracy with respect to identifiers (e.g., so that accuracy of the model with respect to embeddings is prioritized). Thus, the custom loss function may penalize the model more heavily with respect to accuracy of content item embeddings, and may penalize the model less heavily respect to accuracy of content item identifiers. Embeddings provide a more contextualized representation of a content item than identifiers, so prioritizing accuracy with respect to embeddings may result in a more accurate model. In other embodiments, the custom loss function may penalize the model equally when it is not converging towards accuracy with respect to content item embeddings and content item identifiers.

It is noted that descriptions of custom loss functions herein are included as examples, and are not limiting. Other loss functions may be utilized without departing from the scope of the present disclosure.

### Example Machine Learning Model for Content Prediction

FIG. 2 is an illustration 200 of an example machine learning model for content prediction. Illustration 200 includes content prediction model 150 of FIG. 1.

User features 202 of a user are provided as inputs to content prediction model 150. User features 202 include user attributes 210 and page sequence 220. User attributes 210 may include descriptive attributes of a user, while page sequence 220 may include clickstream data indicating a sequence of pages accessed by the user prior to the user accessing the page on which content is to be recommended.

Content prediction model 150 comprises embedding space 252, which generally produces embeddings of user features (e.g., page sequence 220) for processing in subsequent layers of the model. Content prediction model 150 further comprises an LSTM layer 254, which further refines embeddings produced by embedding space 252 by modifying vectors based on remembered data (e.g., remembered input values, such as earlier or subsequent embeddings over certain time intervals in both a backward direction and a forward direction), thereby providing a more contextualized representation of input data.

Content prediction model 150 further comprises a first hidden layer 256 that received user attributes 210 of user features 202. It is noted that alternative embodiments may involve providing user attributes 210 to embedding space 252. A hidden layer in a machine learning model generally represents a layer that lies between an input layer and an output layer, and thus is “hidden” within the model. Hidden layers generally include neurons that apply functions to different combinations of input features, such as to determine probability scores for one or more potential output labels.

Outputs of LSTM layer 254 and/or hidden layer 256 are further processed through a second hidden layer 258, such as for combined processing of data related to user attributes 210 and page sequence 220 (e.g., combining the outputs from LSTM layer 254 and hidden layer 256). Outputs of hidden layer 258 are further processed through two separate hidden layers 260 and 262, such as in parallel, in order to focus on probabilities with respect to different types of output labels (e.g., content identifiers on the one hand and embeddings on the other hand). While not shown, content prediction model 150 may also comprise one or more output layers from which, ultimately, content prediction model 150 outputs one or more content identifiers 272 and one or more embeddings 274. In some embodiments, rather than outputting identifiers and/or embeddings directly, content prediction model 150 outputs numerical values between 0 and 1 indicating a probability that a content item corresponding to a given identifier or embedding is relevant to the user corresponding to user features 202. For example, content prediction model 150 may output a series of probabilities corresponding to all possible embeddings and/or identifiers for which the model has been trained, each probability indicating a likelihood that a given embedding or identifier (e.g., that corresponds to an index associated with the probability in the output from model) is relevant to the user. Thus, the probabilities output by content prediction model 150 may indicate which identifiers and/or embeddings are likely to be relevant to the user.

During training, parameters of content prediction model 150 are iteratively adjusted based on outputs 272 and 274 through a back-propagation process using a loss function, such as the custom loss function as described above with respect to FIG. 1.

Once content prediction model 150 has been trained, outputs from content prediction model 150 are used to recommend content items to users. For instance, content items corresponding to embeddings and/or identifiers output by content prediction model 150 based on input features of a given user may be recommended to the given user. In some cases, every content item corresponding to every embedding and/or identifier output by the content prediction model 150 is recommended to the user. In some cases, an identifier and an embedding output by the model may correspond to the same content item, in which case the content item is only recommended once.

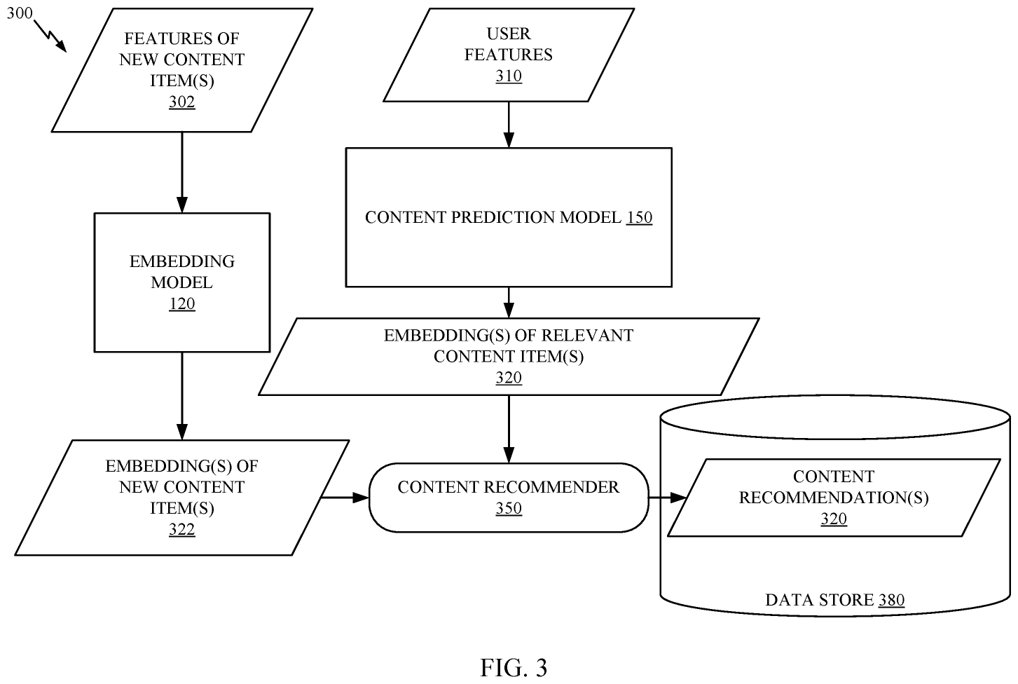

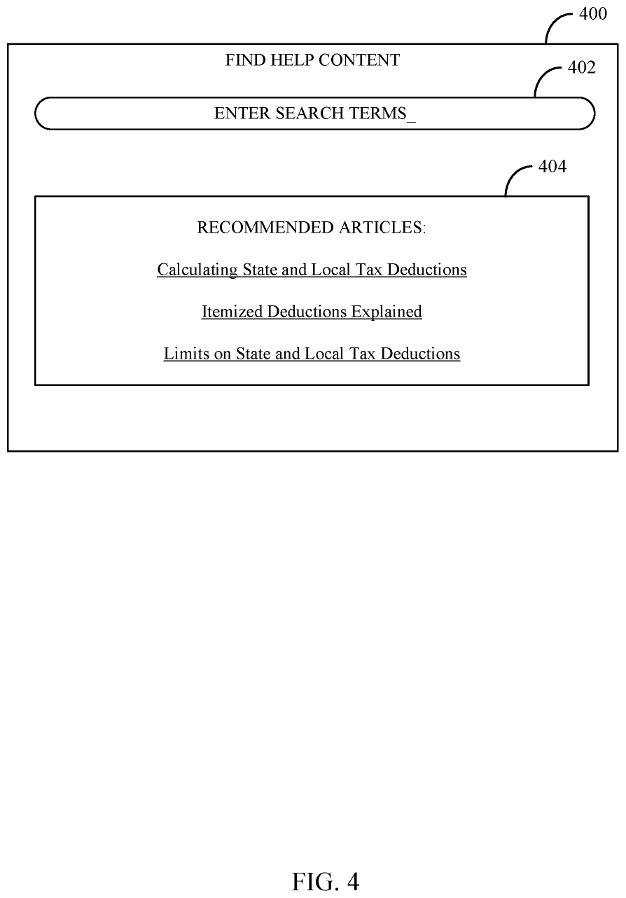

In some embodiments, as described in more detail below with respect to FIG. 3, embeddings output by content prediction model 150 may be used to identify other similar content items to recommend. For instance, a similarity measure between an embedding output by content prediction model 150 and an embedding of another content item (e.g., that was not included in the training data for content prediction model 150) may exceed a threshold, and so the other content item may also be recommended to the user. As described in more detail below with respect to FIG. 4, content items may be recommended to users via a user interface, such as by displaying links to recommended articles in a help page of an application.

### Example Content Recommendation

FIG. 3 is an illustration 300 of an example related to content recommendation using machine learning techniques. Illustration 300 includes embedding model 120 and content prediction model 150 of FIG. 1. For example, a user may have accessed a help page in an application, and example 300 may relate to determining help articles to recommend to the user via the help page. Help articles are included as an example, and other types of content may be recommended using techniques described herein.

User features 310 of the user are provided as inputs to content prediction model 150, which may have been trained as described above with respect to FIGS. 1 and 2. In response to the inputs, content prediction model 150 outputs embeddings (and, in some embodiments, identifiers) of relevant content items 320, which are provided to a content recommender 350. Content recommender 350 generally represents a component that performs operations related to recommending content items to users. Content recommender 350 may, for example, output content items corresponding to the embeddings 320 as content recommendations 320. In some embodiments, content recommendations 320 are stored in a data store 380 (e.g., a data storage entity such as a database or repository), from which they are retrieved for presentation to the user via a user interface.

Furthermore, new content items may be created or become available (e.g., after the training of content prediction model 150). Features 302 of these new content items are provided as inputs to embedding model 120 (e.g., as the new content items become available), which outputs embeddings 322 of the new content items. Embeddings 322 of the new content items may be generated on an ongoing basis as the new content items become available, and may be stored for comparison with outputs of content prediction model 150. For example, at content recommendation time (e.g., when the user accesses a page, such as a help page, on which content is to be recommended), embeddings 322 of the new content items are provided to content recommender 350 for use in determining whether any new content items may also be recommended to the user based on the embeddings 320 output by content prediction model 150. Content recommender 350 may determine similarity measures between embeddings 322 and embeddings 320 to determine whether any of embeddings 322 are similar to any of embeddings 320. Any new content items with embeddings that are similar to those output by content prediction model 150 may also be recommended to the user as content recommendations 320.

### Example User Interface for Content Recommendation

FIG. 4 depicts an example screen 400 of a user interface for content recommendation. In an embodiment, screen 400 represents a screen of a user interface of an application through which a user accesses content items, such as help articles.

In one example, a user having a particular set of user attributes accesses screen 400 within the application after accessing one or more other pages (e.g., which are indicated in clickstream data). Screen 400 includes a control 402 by which the user may search for help content by entering text. Screen 400 further includes content recommendations 404, which comprise help articles that are predicted to be relevant to the user, such as using content prediction model 150 as described above with respect to FIGS. 1-4. Content recommendations 404 may be “pre-search” recommendations, as they are provided to the user before the user has searched for content, and represent content items predicted to be relevant to the user. In an example, the features of the user (e.g., user attributes and clickstream data) are provided as inputs to content recommendation model 150 of FIGS. 1-3, and content recommendations are determined based on outputs from the model. The model may have been trained based on embeddings determined using embedding model 120 of FIGS. 1 and 2, as described above.

Content recommendations 404 include articles entitled “calculating state and local tax deductions,” “itemized deductions explained,” and “limits on state and local tax deductions.” For instance, the user's features may indicate that the user is likely to be interested in information related to particular types of itemized tax deductions, as determined using machine learning techniques described herein.

It is noted that screen 400 is included as an example, and other screens, user interfaces, methods of content recommendation, and types of content may be utilized without departing from the scope of the present disclosure. For instance, machine learning techniques described herein may be used to determine social media, video, audio, literary, news, academic, medical, or other types of content to recommend to a user, and the content may be recommended in a variety of different ways, such as email, text message, phone call, pop up window, and/or the like.

### Example Operations for Content Recommendation Using Machine Learning

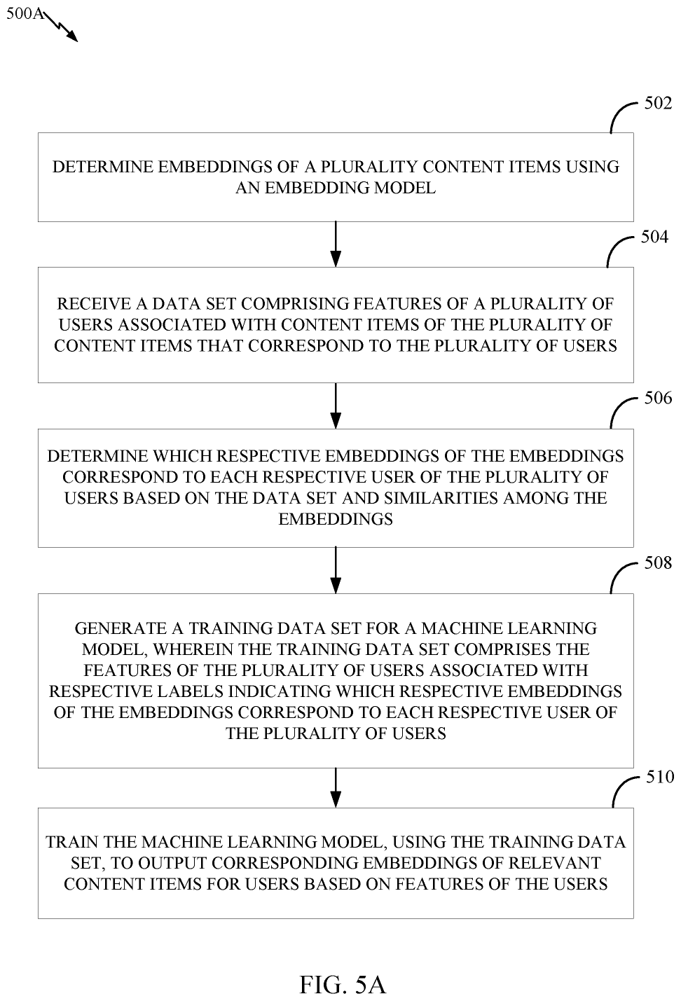

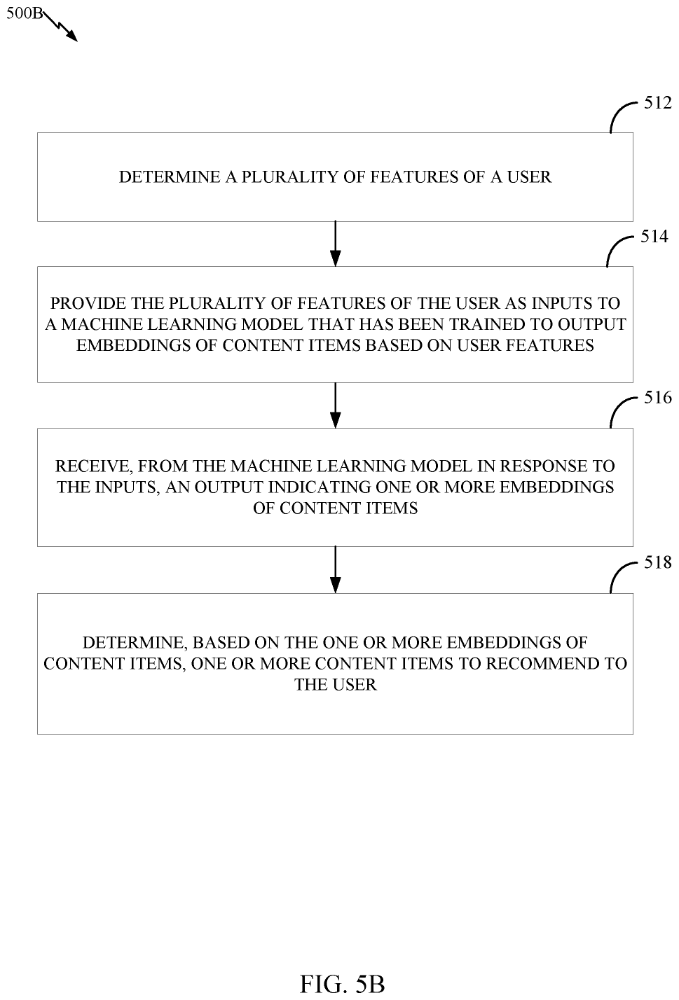

FIG. 5A depicts example operations 500A for content recommendation using machine learning techniques. For example, operations 500A may be performed by model trainer 140 and/or additional components depicted in FIGS. 1-3.

Operations 500A begin at step 502 with determining embeddings of a plurality of content items using an embedding model. For example, features of each of the plurality of content items (e.g., derived from titles of the content items) may be provided as inputs to the embedding model, and the embedding model may output embeddings of the plurality of content items based on the inputs. In some embodiments, the embedding model is a transformer model that is trained to determine embeddings of text sequences.

Operations 500A proceeds to step 504 with receiving a data set comprising features of a plurality of users associated with content items of the plurality of content items that correspond to the plurality of users. For example, the data set may be based on historical application usage data indicating interactions between users with particular features and content items. The features of the plurality of users may include user attributes such as occupation, length of use of an application, tax filing status, and the like, as well as page sequence data (e.g., clickstream data). Content items may include, for example, help articles or other types of content.

Operations 500A proceed to step 506 with determining which respective embeddings of the embeddings correspond to each respective user of the plurality of users based on the data set and similarities among the embeddings. This may include determining similarity measures between embeddings of content items included in the data set and other embeddings included in the embeddings (e.g., corresponding to content items not included in the data set). If a content item not included in the data set has an embedding determined to be similar to an embedding of a content item in the data set (e.g., based on a similarity measure exceeding or falling below a threshold), the content item not included in the data set may be determined to correspond to the same user or users associated with the content item in the data set.

Operations 500A proceed to step 508 with generating a training data set for a machine learning model, wherein the training data set comprises the features of the plurality of users associated with respective labels indicating which respective embeddings of the embeddings correspond to each respective user of the plurality of users. The training data set may further comprise a respective content identifier associated with each respective embedding of the embeddings.

Operations 500A proceed to step 510 with training the machine learning model, using the training data set, to output corresponding embeddings (and, in some embodiments, identifiers) of relevant content items for users based on features of the users. In some embodiments, training the machine learning model includes providing the features of the plurality of users in the training data set as inputs to the machine learning model, comparing outputs received from the machine learning model in response to the inputs to the respective labels in the training data set, and iteratively adjusting one or more parameters of the content prediction model based on the comparing. In some cases, the one or more parameters may be adjusted in order to optimize a value calculated using a custom loss function. In one example, the custom loss function comprises a first component corresponding to embeddings and a second component corresponding to content identifiers, and the first component is parametrized to have a stronger impact on loss than the second component.

Once trained, the machine learning model is used to predict content items that may be relevant to a user based on features of the user, and content items may be recommended to the user based on the predictions. For example, a plurality of features of the user may be provided as inputs to the machine learning model and the machine learning model may output, in response to the inputs, an indication of one or more embeddings of content items. One or more content items may then be recommended to the user determining, based on the one or more embeddings of content items (e.g., which may include recommending content items not indicated in the output that have similar embeddings to the content items indicated in the output). For example, the content items may be recommended to the user via a user interface.

Some embodiments include receiving feedback data indicating whether a content item recommended based on an output from the machine learning model was relevant to a user and adding, removing, or modifying one or more training data instances in the training data set based on the feedback data to produce an updated training data set. The machine learning model may be re-trained based on the updated training data set. Furthermore, new content items may be created or become available after the training of the machine learning model. As such, some embodiments include receiving data related to a new content item and determining an embedding of the new content item using the embedding model, based on the data related to the new content item. If the embedding of the new content item is determined to be similar to a given embedding in the training data set that corresponds to a given set of user features, the training data set may be updated to include an association between the embedding of the new content item and the given set of user features to produce an updated training data set. The machine learning model may then be-retrained based on the updated training data set.

Notably, operations 500A is just one example with a selection of example steps, but additional methods with more, fewer, and/or different steps are possible based on the disclosure herein.

FIG. 5B depicts example operations 500B for content recommendation using machine learning techniques. For example, operations 500B may be performed by content recommender 350 and/or additional components depicted in FIGS. 1-3.

Operations 500B begin at step 512 with determining a plurality of features of a user;

Operations 500B proceed to step 514 with providing the plurality of features of the user as inputs to a machine learning model that has been trained to output embeddings of content items based on user features.

Operations 500B proceed to step 516 with receiving, from the machine learning model in response to the inputs, an output indicating one or more embeddings of content items.

Operations 500B proceed to step 518 with determining, based on the one or more embeddings of content items, one or more content items to recommend to the user. Notably, operations 500B is just one example with a selection of example steps, but additional methods with more, fewer, and/or different steps are possible based on the disclosure herein.

### Example Computing Systems

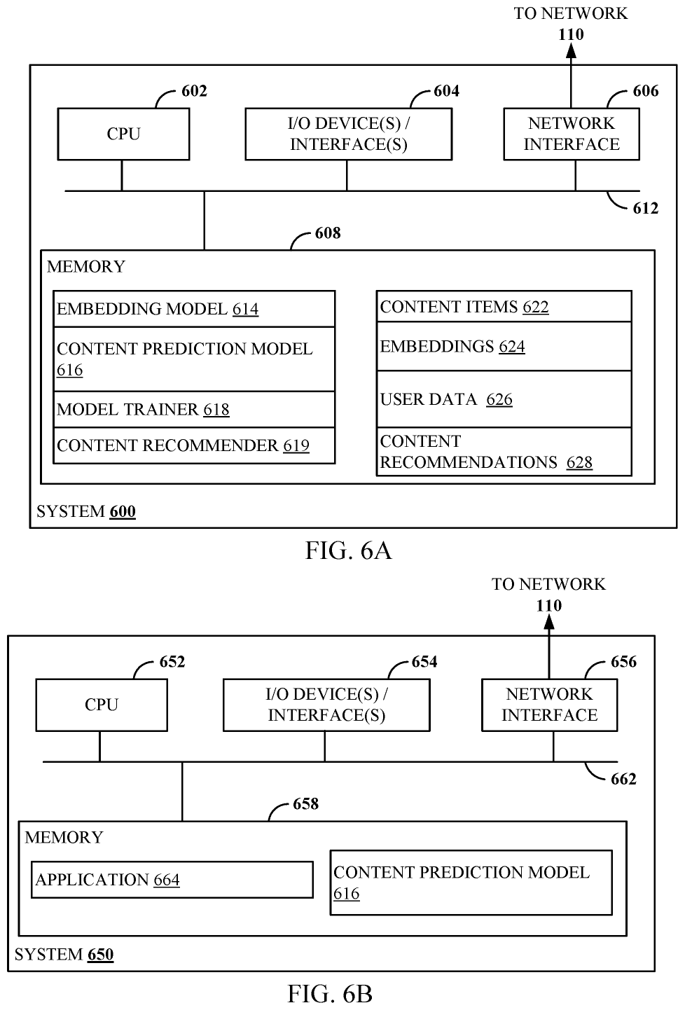

FIG. 6A illustrates an example system 600 with which embodiments of the present disclosure may be implemented. For example, system 600 may be configured to perform operations 500A of FIG. 5A and/or operations 500B of FIG. 5B.

System 600 includes a central processing unit (CPU) 602, one or more I/O device interfaces 604 that may allow for the connection of various I/O devices 614 (e.g., keyboards, displays, mouse devices, pen input, etc.) to the system 600, network interface 606, a memory 608, and an interconnect 612. It is contemplated that one or more components of system 600 may be located remotely and accessed via a network 110. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes embedding model 614, content prediction model 616, model trainer 618, and content recommender 619, which may be representative of embedding model 120, content prediction model 150, and model trainer 140 of FIG. 1 and content recommender 350 of FIG. 3.

Memory 608 further comprises content items 622, which may include items of content that can be recommended to users, such as help articles. Memory 608 further comprises embeddings 624, which may be representative of vector representations of content items 622. Memory 608 further comprises user data 626, which may be representative of user features of one or more users. Memory 608 further comprises content recommendations 628, which may be representative of recommendations of content items that can be provided to a user via a user interface, such as via application 664 of FIG. 6B.

FIG. 6B illustrates an example system 650 with which embodiments of the present disclosure may be implemented. For example, system 650 may be a user device that is used to access content via application 664, and content may be recommended to the user via system 650 using techniques described herein.

System 650 includes a central processing unit (CPU) 652, one or more I/O device interfaces 654 that may allow for the connection of various I/O devices 654 (e.g., keyboards, displays, mouse devices, pen input, etc.) to the system 650, network interface 656, a memory 658, and an interconnect 662. It is contemplated that one or more components of system 650 may be located remotely and accessed via a network 110. It is further contemplated that one or more components of system 650 may comprise physical components or virtualized components.

CPU 652 may retrieve and execute programming instructions stored in the memory 658. Similarly, the CPU 652 may retrieve and store application data residing in the memory 658. The interconnect 662 transmits programming instructions and application data, among the CPU 652, I/O device interface 654, network interface 656, and memory 658. CPU 652 is included to be representative of a single CPU, multiple CPUs, a single CPU having multiple processing cores, and other arrangements.

Additionally, the memory 658 is included to be representative of a random access memory or the like. In some embodiments, memory 658 may comprise a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

As shown, memory 658 includes an application 664. In some embodiments, application 664 provides a user interface (e.g., corresponding to screen 400 of FIG. 4) by which a user accesses content items and content recommendations determined using techniques described herein (e.g., provided by content recommender 619 of FIG. 6A). Optionally, memory 658 may also include an instance of content prediction model 616. For example, in some cases, content prediction model 616 is used to determine content recommendations locally on system 650 to provide to the user via application 664, rather than determining the recommendations remotely from system 600 and sending the recommendations to system 650. Content prediction model 616 may be suitable for running on a client device, as it is a lightweight model that incorporates knowledge from a larger model (e.g., embedding model 614 of FIG. 6A).

### EXAMPLE CLAUSES

Clause 1: A method for training a machine learning model, comprising: providing features of a plurality of content items as inputs to an embedding model; receiving embeddings of the plurality of content items as outputs from the embedding model based on the inputs; receiving a data set comprising features of a plurality of users associated with content items of the plurality of content items that correspond to the plurality of users; determining which respective embeddings of the embeddings correspond to each respective user of the plurality of users based on the data set and similarities among the embeddings; generating a training data set for a machine learning model, wherein the training data set comprises the features of the plurality of users associated with respective labels indicating which respective embeddings of the embeddings correspond to each respective user of the plurality of users; and training the machine learning model, using the training data set, to output corresponding vector representations of relevant content items for users based on features of the users.

Clause 2: The method of Clause 1, wherein training the machine learning model is based on a custom loss function that relates to mean squared error and categorical cross-entropy.

Clause 3: The method of any one of Clause 1-2, wherein determining which respective embeddings of the embeddings correspond to each respective user of the plurality of users based on the data set and similarities among the embeddings comprises identifying at least one embedding of the embeddings that corresponds to a content item that is not included in the data set that corresponds to a given user of the plurality of users based on the similarities among the embeddings.

Clause 4: The method of any one of Clause 1-3, wherein: the training data set further comprises a respective content identifier associated with each respective embedding of the embeddings; and the machine learning model is further trained to output corresponding content identifiers of the relevant content items.

Clause 5: The method of Clause 4, wherein training the machine learning model is based on a custom loss function comprising a first component corresponding to embeddings and a second component corresponding to content identifiers, and wherein the first component is parametrized to have a stronger impact on loss than the second component.

Clause 6: The method of any one of Clause 1-5, wherein training the machine learning model comprises: providing the features of the plurality of users in the training data set as inputs to the machine learning model; comparing outputs received from the machine learning model in response to the inputs to the respective labels in the training data set; and iteratively adjusting one or more parameters of the machine learning model based on the comparing.

Clause 7: The method of any one of Clause 1-6, further comprising: receiving feedback data indicating whether a content item recommended based on an output from the machine learning model was relevant to a user; adding, removing, or modifying one or more training data instances in the training data set based on the feedback data to produce an updated training data set; an re-training the machine learning model based on the updated training data set.

Clause 8: The method of any one of Clause 1-7, further comprising receiving data related to a new content item; determining an embedding of the new content item using the embedding model, based on the data related to the new content item; determining that the embedding of the new content item is similar to a given embedding in the training data set that corresponds to a given set of user features; adding, to the training data set, an association between the embedding of the new content item and the given set of user features to produce an updated training data set; and re-training the machine learning model based on the updated training data set.

Clause 9: A method for recommending content, comprising determining a plurality of features of a user; providing the plurality of features of the user as inputs to a machine learning model that has been trained to output embeddings of content items based on user features; receiving, from the machine learning model in response to the inputs, an output indicating one or more embeddings of content items; and determining, based on the one or more embeddings of content items, one or more content items to recommend to the user.

Clause 10: The method of Clause 9, further comprising recommending, via a user interface, the one or more content items to the user.

Clause 11: The method of any one of Clause 9-10, further comprising: receiving data related to a new content item; determining an embedding of the new content item using an embedding model, based on the data related to the new content item; and determining whether to recommend the new content item to the user based on a similarity between the embedding of the new content item and the one or more embeddings of content items indicated in the output from the machine learning model.

Clause 12: The method of Clause 11, wherein the similarity between the embedding of the new content item and the one or more embeddings of the content items indicated in the output from the machine learning model is determined using cosine similarity.

Clause 13: The method of any one of Clause 9-12, further comprising receiving one or more identifiers of one or more content items as additional output from the machine learning model.

Clause 14: The method of any one of Clause 9-13, wherein determining the plurality of features of the user comprises determining clickstream data and one or more attributes of the user.

Clause 15: A system for training a machine learning model, comprising: one or more processors; and a memory comprising instructions that, when executed by the one or more processors, cause the system to: provide features of a plurality of content items as inputs to an embedding model; receive embeddings of the plurality of content items as outputs from the embedding model based on the inputs; receive a data set comprising features of a plurality of users associated with content items of the plurality of content items that correspond to the plurality of users; determine which respective embeddings of the embeddings correspond to each respective user of the plurality of users based on the data set and similarities among the embeddings; generate a training data set for a machine learning model, wherein the training data set comprises the features of the plurality of users associated with respective labels indicating which respective embeddings of the embeddings correspond to each respective user of the plurality of users; and train the machine learning model, using the training data set and based on a custom loss function that relates to mean squared error and categorical cross-entropy, to output corresponding vector representations of relevant content items for users based on features of the users.

Clause 16: The system of Clause 15, wherein the instructions, when executed by the one or more processors, further cause the system to: receive data related to a new content item; determine an embedding of the new content item using the embedding model, based on the data related to the new content item; determine that the embedding of the new content item is similar to a given embedding in the training data set that corresponds to a given set of user features; add, to the training data set, an association between the embedding of the new content item and the given set of user features to produce an updated training data set; and re-train the machine learning model based on the updated training data set.

Clause 17: The system any one of Clause 15-16, wherein determining which respective embeddings of the embeddings correspond to each respective user of the plurality of users based on the data set and similarities among the embeddings comprises identifying at least one embedding of the embeddings that corresponds to a content item that is not included in the data set that corresponds to a given user of the plurality of users based on the similarities among the embeddings.

Clause 18: The system of any one of Clause 15-17, wherein: the training data set further comprises a respective content identifier associated with each respective embedding of the embeddings; and the machine learning model is further trained to output corresponding content identifiers of the relevant content items.

Clause 19: The system of Clause 18, wherein training the machine learning model is based on a custom loss function comprising a first component corresponding to embeddings and a second component corresponding to content identifiers, and wherein the first component is parametrized to have a stronger impact on loss than the second component.

Clause 20: The system of any one of Clause 15-19, wherein training the machine learning model comprises: providing the features of the plurality of users in the training data set as inputs to the machine learning model; comparing outputs received from the machine learning model in response to the inputs to the respective labels in the training data set; and iteratively adjusting one or more parameters of the machine learning model based on the comparing.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a machine learning model, comprising:
providing features of a plurality of content items as inputs to an embedding model;
receiving embeddings of the plurality of content items as outputs from the embedding model based on the inputs;
receiving a data set comprising features of a plurality of users associated with content items of the plurality of content items that correspond to the plurality of users;
determining which respective embeddings of the embeddings correspond to each respective user of the plurality of users based on the data set and similarities among the embeddings;
generating a training data set for a machine learning model, wherein the training data set comprises the features of the plurality of users associated with respective labels indicating which respective embeddings of the embeddings correspond to each respective user of the plurality of users; and
training the machine learning model, using the training data set, to output corresponding vector representations of relevant content items for users based on features of the users.

2. The method of claim 1, wherein training the machine learning model is based on a custom loss function that relates to mean squared error and categorical cross-entropy.

3. The method of claim 1, wherein determining which respective embeddings of the embeddings correspond to each respective user of the plurality of users based on the data set and similarities among the embeddings comprises identifying at least one embedding of the embeddings that corresponds to a content item that is not included in the data set that corresponds to a given user of the plurality of users based on the similarities among the embeddings.

4. The method of claim 1, wherein:
the training data set further comprises a respective content identifier associated with each respective embedding of the embeddings; and
the machine learning model is further trained to output corresponding content identifiers of the relevant content items.

5. The method of claim 4, wherein training the machine learning model is based on a custom loss function comprising a first component corresponding to embeddings and a second component corresponding to content identifiers, and wherein the first component is parametrized to have a stronger impact on loss than the second component.

6. The method of claim 1, wherein training the machine learning model comprises:
providing the features of the plurality of users in the training data set as inputs to the machine learning model;
comparing outputs received from the machine learning model in response to the inputs to the respective labels in the training data set; and
iteratively adjusting one or more parameters of the machine learning model based on the comparing.

7. The method of claim 1, further comprising:
receiving feedback data indicating whether a content item recommended based on an output from the machine learning model was relevant to a user;
adding, removing, or modifying one or more training data instances in the training data set based on the feedback data to produce an updated training data set; and
re-training the machine learning model based on the updated training data set.

8. The method of claim 1, further comprising:
receiving data related to a new content item;
determining an embedding of the new content item using the embedding model, based on the data related to the new content item;
determining that the embedding of the new content item is similar to a given embedding in the training data set that corresponds to a given set of user features;
adding, to the training data set, an association between the embedding of the new content item and the given set of user features to produce an updated training data set; and
re-training the machine learning model based on the updated training data set.

9. A method for recommending content, comprising:
determining a plurality of features of a user;
providing the plurality of features of the user as inputs to a machine learning model that has been trained to output embeddings of content items based on user features;
receiving, from the machine learning model in response to the inputs, an output indicating one or more embeddings of content items; and
determining, based on the one or more embeddings of content items, one or more content items to recommend to the user.

10. The method of claim 9, further comprising recommending, via a user interface, the one or more content items to the user.

11. The method of claim 9, further comprising:
receiving data related to a new content item;
determining an embedding of the new content item using an embedding model, based on the data related to the new content item; and
determining whether to recommend the new content item to the user based on a similarity between the embedding of the new content item and the one or more embeddings of content items indicated in the output from the machine learning model.

12. The method of claim 11, wherein the similarity between the embedding of the new content item and the one or more embeddings of the content items indicated in the output from the machine learning model is determined using cosine similarity.

13. The method of claim 9, further comprising receiving one or more identifiers of one or more content items as additional output from the machine learning model.

14. The method of claim 9, wherein determining the plurality of features of the user comprises determining clickstream data and one or more attributes of the user.

15. A system for training a machine learning model, comprising:
one or more processors; and
a memory comprising instructions that, when executed by the one or more processors, cause the system to:
provide features of a plurality of content items as inputs to an embedding model;
receive embeddings of the plurality of content items as outputs from the embedding model based on the inputs;
receive a data set comprising features of a plurality of users associated with content items of the plurality of content items that correspond to the plurality of users;
determine which respective embeddings of the embeddings correspond to each respective user of the plurality of users based on the data set and similarities among the embeddings;
generate a training data set for a machine learning model, wherein the training data set comprises the features of the plurality of users associated with respective labels indicating which respective embeddings of the embeddings correspond to each respective user of the plurality of users; and
train the machine learning model, using the training data set and based on a custom loss function that relates to mean squared error and categorical cross-entropy, to output corresponding vector representations of relevant content items for users based on features of the users.

16. The system of claim 15, wherein the instructions, when executed by the one or more processors, further cause the system to:
receive data related to a new content item;
determine an embedding of the new content item using the embedding model, based on the data related to the new content item;
determine that the embedding of the new content item is similar to a given embedding in the training data set that corresponds to a given set of user features;
add, to the training data set, an association between the embedding of the new content item and the given set of user features to produce an updated training data set; and
re-train the machine learning model based on the updated training data set.

17. The system of claim 15, wherein determining which respective embeddings of the embeddings correspond to each respective user of the plurality of users based on the data set and similarities among the embeddings comprises identifying at least one embedding of the embeddings that corresponds to a content item that is not included in the data set that corresponds to a given user of the plurality of users based on the similarities among the embeddings.

18. The system of claim 15, wherein:
the training data set further comprises a respective content identifier associated with each respective embedding of the embeddings; and
the machine learning model is further trained to output corresponding content identifiers of the relevant content items.

19. The system of claim 18, wherein training the machine learning model is based on a custom loss function comprising a first component corresponding to embeddings and a second component corresponding to content identifiers, and wherein the first component is parametrized to have a stronger impact on loss than the second component.

20. The system of claim 15, wherein training the machine learning model comprises:
providing the features of the plurality of users in the training data set as inputs to the machine learning model;
comparing outputs received from the machine learning model in response to the inputs to the respective labels in the training data set; and
iteratively adjusting one or more parameters of the machine learning model based on the comparing.
